(19) United States
(12) Patent Application Publication
(10) Pub. No.: US 2020/0273103 A1
(43) Pub. Date: Aug. 27, 2020

(54) ROBUST SECURITY VOLATILITY ESTIMATION USING INTRADAY TRANSACTION DATA

(71) Applicant: The University of Chicago, Chicago, IL (US)

(72) Inventors: Dacheng XIU, Chicago, IL (US); Rui DA, Chicago, IL (US)

(21) Appl. No.: 16/650,730

(22) PCT Filed: Sep. 25, 2018
(86) PCT No.: PCT/US2018/052617

§ 371 Date: Mar. 25, 2020

Related U.S. Application Data
(60) Provisional application No. 62/562,709, filed on Sep. 25, 2017.

(51) Int. Cl. G06Q 40/04; G06F 17/18; G06T 11/20

(52) U.S. Cl. CPC G06Q 40/04; G06T 2200/24; G06T 11/206; G06F 17/18

(57) ABSTRACT

A security price volatility estimator that is capable of accurately estimating price volatility in real-time or near real-time, and in low noise and high noise environments. Embodiments cover an interactive tool that allows or instructs a user to make meaningful decisions based on the estimated volatility. The estimator is constructed based on the assumption that the transaction price of a security comprises the sum of (1) a latent efficient security price that follows a general Ito\hat{ } semimartingale, and (2) a market microstructure noise component that follows a discrete-time moving-average (MA)(∞) process associated with the random execution of trades. The estimator is obtained by using a tractable Quasi-Maximum Likelihood Estimator (QMLE), which relies on a simple yet mis-specified moving-average MA(q+1) model for observed returns. The order of q is preferably selected based on Akaike Information Criteria (AIC) or Bayesian Information Criteria (BIC).

### CROSS-REFERENCE TO RELATED APPLICATIONS

This application claims the benefit of priority of U.S. Provisional Patent Application No. 62/562,709 filed Sep. 25, 2017, which is hereby incorporated by reference in its entirety.

### TECHNICAL FIELD

The present disclosure generally relates to estimating volatility of securities. More specifically, the present disclosure relates to estimating security volatility based on intraday price information in both high and low noise environments.

### BACKGROUND

Estimating volatility is central to modern finance and has many applications, including risk management, derivative pricing, and a complement to credit rating. An approach to estimating volatility is to consider historical data for the security whose volatility is to be estimated. Volatilities calculated in this manner are called historical volatilities. Historical volatilities are routinely used in applications (such as value-at-risk or portfolio theory) where volatilities are required for quantities on which options are not traded. Financial analysts also might use historical volatilities to confirm or supplement implied volatility estimates.

Historical volatility reflects actual market fluctuations. However, the data upon which historical volatility is based may be staleperhaps encompassing a period not reflective of current market conditions. As such, using high-frequency intra-day trades, rather than daily closing prices, provides a much higher accurate measure of historical volatility. However, this concept is difficult to implement because of market-micro-structure noise problems such as “bid-ask bounce.” Accordingly, there is a need for an estimator that (1) provides a realistic measure of volatility not limited by arbitrarily-selected times, and (2) accurately measures volatility in both low noise and high noise environments.

### SUMMARY

In view of the foregoing, one described embodiment provides a method for estimating the volatility of a security based on intraday trading data relating to that security. According to the method, security transaction price data that is sampled during a time interval is received. Then, the received security transaction price data is filtered to remove unreliable data. A volatility estimator is calculated from the filtered samples of transaction price data of a security. In calculating the estimator, it is assumed that a transaction price of a security comprises: a sum of (1) a latent efficient security price that follows a general Itô semimartingale, and (2) a market microstructure noise component that follows a discrete-time moving-average (MA)(∞) associated with the random execution of trades. The estimator is further calculated by maximizing the likelihood of a mis-specified moving-average (MA) model of returns with homoscedastic innovations. Then, a Quasi-Maximum Likelihood Estimator (QMLE) is utilized to determine volatility and noise for the security. Based on the determined volatility and noise, a user to take one or more actions via an interactive tool.

Another embodiment provides a system for estimating the volatility of a security based on intraday trading data relating to that security. The system comprises a memory and one or more processor coupled to the memory. The one or more processors perform certain functions to estimate volatility. Accordingly, a security transaction price data that is sampled during a time interval is received. Then, the received security transaction price data is filtered to remove unreliable data. A volatility estimator is calculated from the filtered samples of transaction price data of a security. In calculating the estimator, it is assumed that a transaction price of a security comprises: a sum of (1) a latent efficient security price that follows a general Itô semimartingale, and (2) a market microstructure noise component that follows a discrete-time moving-average (MA)(∞) associated with the random execution of trades. The estimator is further calculated by maximizing the likelihood of a mis-specified moving-average (MA) model of returns with homoscedastic innovations. Then, a Quasi-Maximum Likelihood Estimator (QMLE) is utilized to determine volatility and noise for the security. Based on the determined volatility and noise, a user to take one or more actions via an interactive tool.

The foregoing has outlined rather broadly the features and technical advantages of the present invention in order that the detailed description of the invention that follows may be better understood. Additional features and advantages of the invention will be described hereinafter which form the subject of the claims of the invention. It should be appreciated by those skilled in the art that the conception and specific embodiment disclosed may be readily utilized as a basis for modifying or designing other structures for carrying out the same purposes of the present invention. It should also be realized by those skilled in the art that such equivalent constructions do not depart from the spirit and scope of the invention as set forth in the appended claims. The novel features which are believed to be characteristic of the invention, both as to its organization and method of operation, together with further objects and advantages will be better understood from the following description when considered in connection with the accompanying figures. It is to be expressly understood, however, that each of the FIGs. is provided for the purpose of illustration and description only and is not intended as a definition of the limits of the present invention.

### DESCRIPTION OF DRAWINGS

For a more complete understanding of the present disclosure, reference is now made to the following descriptions taken in conjunction with the accompanying figures, in which:

FIG. 1 illustrates an overview of a method for estimating volatility of a security according to an embodiment;

FIG. 2A shows a quadratic representation of an exact weighting matrix (QMLE) in the case of i.i.d. noise according to an embodiment;

FIG. 2B shows a quadratic representation of a Whittle weighting matrix in the case of i.i.d. noise according to an embodiment;

FIG. 2C shows a quadratic representation of an exact weighting matrix (QMLE) in the case of MA(5) noise according to an embodiment;

FIG. 3A shows a histogram for the standardized estimate of volatility under a first estimated asymptotic condition according to an embodiment;

FIG. 3B shows a histogram for the standardized estimate of the variance of the under the first estimated asymptotic condition according to an embodiment;

FIG. 3C shows a histogram for the standardized estimate of the variance of noise under the first estimated asymptotic condition according to an embodiment;

FIG. 3D shows a histogram for the standardized estimate of the first order auto-covariance of noise under a second estimated asymptotic condition according to an embodiment;

FIG. 3E shows a histogram for a second standardized estimate of the second order auto-covariance of noise under a third estimated asymptotic condition according to an embodiment;

FIG. 3F shows a histogram for a second standardized estimate of the third order auto-covariance of noise under a fourth estimated asymptotic condition according to an embodiment;

FIG. 3G shows a histogram for a second standardized estimate of the fourth order auto-covariance of noise under a fifth estimated asymptotic condition according to an embodiment;

FIG. 3H shows a histogram for a second standardized estimate of the fifth order auto-covariance of noise under a sixth estimated asymptotic condition according to an embodiment;

FIG. 4A illustrates a histogram for a selected order using AIC according to an embodiment;

FIG. 4B illustrates a histogram for a selected order using BIC according to an embodiment;

FIG. 4C illustrates a histogram for the standardized volatility estimates using AIC according to an embodiment;

FIG. 4D illustrates a histogram for the standardized volatility estimates using BIC according to an embodiment;

FIG. 5A shows a histogram for the standardized volatility estimates using the central limit results given by Theorem 4(i) in a low noise environment.

FIG. 5B shows a histogram for the standardized volatility estimates using the central limit results given by Theorem 4(i) in a medium noise environment according to an embodiment;

FIG. 5C shows a histogram the standardized volatility estimates using the central limit results given by Theorem 4(i) in a high noise environment according to an embodiment;

FIG. 5D shows a histogram for the standardized volatility estimates using the central limit results given by Theorem 4(ii) in a low noise environment according to an embodiment;

FIG. 5E shows a histogram for the standardized volatility estimates using the central limit results given by Theorem 4(ii) in a medium noise environment according to an embodiment;

FIG. 5F shows a histogram for the standardized volatility estimates using the central limit results given by Theorem 4(ii) in a high noise environment according to an embodiment;

FIG. 5G shows a histogram for the standardized volatility estimates using the central limit results given by Theorem 4(iii) in a low noise environment according to an embodiment;

FIG. 5H shows a histogram for the standardized volatility estimates using the central limit results given by Theorem 4(iii) in a medium noise environment according to an embodiment;

FIG. 5I shows a histogram for the standardized volatility estimates using the central limit results given by Theorem 4(iii) in a high noise environment according to an embodiment;

FIG. 6A illustrates the time series of estimated annualized volatility according to an embodiment;

FIG. 6B illustrates the time series of the variance estimates of noise innovation according to an embodiment;

FIG. 7A shows a plot of percentage bias in the cross-sectional medians of 5-minute volatility estimates, relative to the corresponding QMLEs according to an embodiment;

FIG. 7B shows a histogram of the ratios of standard errors between the 5-minute realized volatility estimator and the QMLE, for each stock-day pair in 2016 according to an embodiment;

FIG. 7C shows a plot of percentage bias in the cross-sectional medians of 15-minute volatility estimates, relative to the corresponding QMLEs according to an embodiment;

FIG. 7D shows a histogram of the ratios of standard errors between the 15-minute realized volatility estimator and the QMLE, for each stock-day pair in 2016 according to an embodiment;

FIG. 8A shows selected orders using BIC for constituents of various indexes in 2016 according to an embodiment;

FIG. 8B provides a histogram of the durations of auto-correlations for tickers with selected lags greater than or equal to 1 in 2016 according to an embodiment;

FIG. 8C shows selected orders using BIC for constituents of various indexes in 2006 according to an embodiment;

FIG. 8D provides a histogram of the durations of auto-correlations for tickers with selected lags greater than or equal to 1 in 2006 according to an embodiment;

FIG. 8E shows selected orders using BIC for constituents of various indexes in 1996 according to an embodiment;

FIG. 8F provides a histogram of the durations of auto-correlations for tickers with selected lags greater than or equal to 1 in 1996 according to an embodiment;

FIG. 9 illustrates a computer-implemented system for estimating volatility of a security according to an embodiment;

FIG. 10 illustrates certain aspects of an interactive tool for estimating volatility presented to a user according to an embodiment; and

FIG. 11 illustrates additional aspects of an interactive tool for estimating volatility presented to a user according to an embodiment; and

### DETAILED DESCRIPTION

Embodiments are directed to a security price or future price volatility estimator that is capable of accurately estimating price volatility in real-time or near real-time based on intraday trading, and in low noise and high noise environments. Embodiments are further directed to an interactive tool that allows or instructs a user to make meaningful decisions based on the estimated volatility. The inventive concepts are discussed herein with further reference to the disclosure documents filed herewith, which are incorporated by reference in their entirety.

According to disclosed embodiments, the estimator is constructed based on the assumption that a transaction price of a security comprises the sum of (1) a latent efficient security price that follows a general Itô semimartingale, and (2) a market microstructure noise component that follows a discrete-time moving-average (MA)(∞) associated with the random execution of trades. The estimator is obtained by maximizing the likelihood of a mis-specified moving-average (MA) model of returns with homoscedastic innovations. While embodiments have features in common with a MA model, their asymptotic design is “in-fill;” i.e., the number of observations of volatility increases in a specified time period. A tractable Quasi-Maximum Likelihood Estimator (QMLE) can be utilized, which relies on a MA(q+1) model for observed returns. The order of q is preferably selected based on Akaike Information Criteria (AIC) or Bayesian Information Criteria (BIC).

While embodiments generally rely upon either AIC or BIC for model selection, they also develop a uniformly valid post-selection inference on volatility, allowing for imperfect model selection. Further, the estimator is adaptive to the presence of the noise, and its convergence rate varies from n^{1/4} to n^{1/2}, depending on the noise magnitude. That is, as noise diminishes, the estimator convergence rate increases from n^{1/4} to n^{1/2}. Accordingly, embodiments provide a uniform inference on volatility across both low noise and high noise environments. In high noise environments, the estimator can be regarded as an iterative flat-top realized kernel. Yet, unlike kernel and other nonparametric estimators, embodiments are tuning-free barring order selection, and warrant positive estimates in finite samples.

Embodiments provide consistent estimators of noise auto-covariances and auto-correlations as by-products that do not rely on a bandwidth choice and guarantee positive volatility estimates. Accordingly, both AIC-QMLE and BIC-QMLE embodiments, as described herein, provide better finite-sample performance than alternative nonparametric estimators.

### Notation And Assumptions

An explanation of notation and certain assumptions used herein is provided to assist in understanding the inventive concepts.

For any matrix A, A^{T}, and A^{†} denote its transpose and Hermitian conjugate, respectively. The Kronecker delta is denoted by δ_{i,j}. The imaginary unit and the indicator function are written as [symbol] and, [symbol] _{{⋅}} respectively. All vectors are column vectors where (a, b, c) are written in place of (a^{T}, b^{T}, c^{T})^{T} for simplicity. Also, d-dimensional vectors of 0s and 1s are written as 0_{d} and 1d and ∥⋅∥ is used to denote the [symbol] ² norm. B denotes the backward (lag) operator associated with a discrete-time time series. K represents a generic positive constant that may vary from line to line but does not depend on n.

All limits are taken as

$$n \to ∞ and {\to }^{ℒ} and {\to }^{ℒ - s}$$

denote convergence in law and stable convergence in law, respectively. The mixed normal distribution is denoted by [symbol] and aₙ≤bₙ if aₙ≤Kbₙ for all n. Also, aₙ˜bₙ if aₙ≤bₙ≤aₙ.

At each stage n≥1, the transaction price of a security \tilde{X} is observed at time points 0≤t₀≤t₁≤ . . . ≤tₙ_{_{T}}≤T. Throughout, n_{T}, the number of observations within [0, T], is assumed to be an observed random variable, where n is a non-observable mathematical abstraction. If sampling is performed at regular intervals, n=n_{T} is used.

According to embodiments, it is assumed that \tilde{X}ₜ_{ᵢ} has two components:

\tilde{X}ₜ_{ᵢ}=Xₜ_{ᵢ}+Uᵢ,0≤i≤n_{T},

where Xₜ_{ᵢ} is the efficient equilibrium security price and Uᵢ is the microstructure noise associated with the ith observation.

Assumptions regarding the efficient price X, the sampling scheme, and the microstructure noise U, are also discussed herein to highlight certain improvements provided by the inventive concepts over other known estimation methods.

Assumption 1: The logarithm of the efficient security price Xₜ is a continuous Itô semimartingale defined on a filtered probability space (Ω, [symbol] , ( [symbol] ₜ), P), which satisfies:

Xₜ=X₀+∫₀^{t}μₛds+∫₀^{t}σₛdWₛ, (1)

where μₜ is predictable and locally bounded, at is a locally bounded Itô semimartingale, and W is a Brownian motion.
Assumption 2: For each n≥1, the sampling intervals are regular. That is, tj−tj−1=Δn for all 1≤j≤n_{T}, where Δn=T/n_{T}, and n_{T}=n.
With respect to U, consider a sequence of MA(∞) models with parameters indexed by n for each stage n. The parameters are indexed to facilitate the subsequent discussion regarding uniformity.
Assumption 3: For each n≥1, the noise U has an MA(∞) representation:

$$\begin{matrix}{U}_{i} = {ι}^{( n )} {{θ}^{( n )} ( B )}_{{ɛ}_{i}} , with {θ}^{( n )} ( x ) = 1 + {\sum }_{j = 1}^{∞} {θ}_{j}^{( n )} {x}^{j} , {θ}^{( n )} ∈ Θ ( ∞ ) , where 0 \leq {ι}^{( n )} \leq K , and & ( 2 ) \\ Θ ( ∞ ) = \{ θ ∈ {∞}^{} \text{:} \frac{1}{K} \leq \begin{matrix}inf \\ x ∈ , \vert x \vert \leq 1\end{matrix} \vert θ ( x ) \vert \text{;} 1 + {{\sum }_{j = 1}}^{∞} j \vert {θ}_{j} \vert \leq K . \} & ( 3 )\end{matrix}$$

Recognizing the strong independence assumption is important for distinguishing volatility associated with the efficient security price from that of the transaction price itself.

According to embodiments, the model of noise is also nonparametric in that θ⁽ⁿ⁾ is an infinite-dimensional parameter vector. It satisfies equation (3), so that the sequence of the MA processes are uniformly invertible and their long-range serial dependence cannot be arbitrarily large.^{≥} The parameter space Θ(∞) is not restrictive. For instance, it allows for any stationary ARMA(p,q) model and any MA(∞) model with coefficients {θⱼ}_{j≥1} decaying at a polynomial rate that is faster than j⁻². These restrictions facilitate an approximation to the likelihood function upon which embodiments of the estimator are constructed.

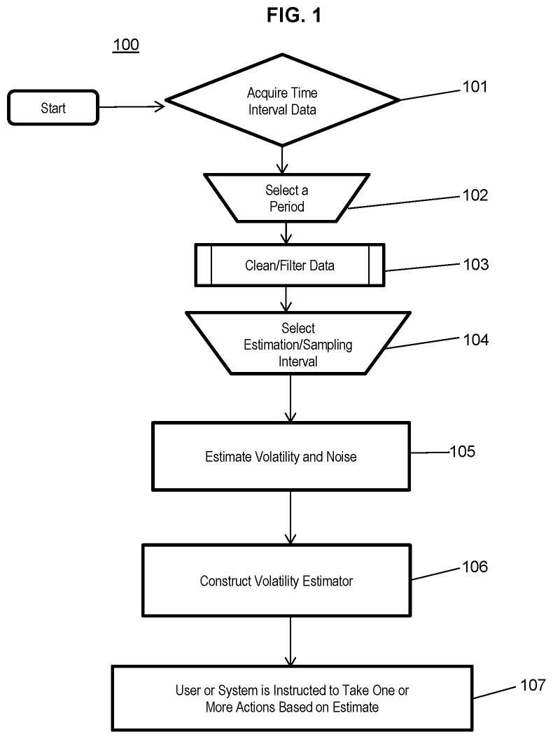

With the foregoing concepts in mind, FIG. 1 illustrates an overview of method 100 for estimating volatility of a security according to inventive concepts described herein. The method can be executed by a specialized computer for performing volatility estimation, and the computer system components can be co-located or distributed relative to each other.

At step 101, a time interval over which security transaction price data will be collected is determined. This can be manually selected by a user or automatically selected according to system parameters and the like. However, according to a preferred embodiment, security transaction price data will be collected or sampled at a high frequency during one or more trading days.

Referring step 102, the total period over which volatility is estimated may be selected by the user to be one or higher of a minute, hour, day, week, month, year, or multiple years. For simplicity, the description hereinafter shows the constants used to determine an intraday volatility, i.e., an intra-period volatility for one day.

A security or underlying asset involved with intra-period volatility may include but is not be limited to following instruments: security, bonds, loans, private placements, forward contracts, futures contracts, swaps, forward swaps/delayed start swaps, break forwards, calls, puts, straddles/strangles/butterflies, reverse floating rate loan/bull floating rate notes, dual currency bonds, callable/puttable bonds, puttable stock, bond with warrant, convertible bonds, liquid yield option notes, commodity-linked bonds, auction rate notes/debentures, collateralized mortgage obligations/real estate mortgage investment conduits, commercial real-estate backed bonds, credit enhanced debt securities, dollar bills, foreign exchange paper, floating/rate sensitive notes, floating rate tax-exempt revenue bonds, increasing rate notes, indexed currency option notes or principal exchange rate linked securities, caps/floors/collars, interest rate reset notes, mortgage pass-through certificates, negotiable certificates of deposit, adjustable tender securities, puttable/extendable notes, real yield securities, receivable pay-through securities, remarketed reset notes, stripped mortgage backed securities, stripped treasuries/municipals, variable coupon renewable notes, variable rate renewable notes, yield curve/maximum rate notes, adjustable rate preferred stock, auction rate preferred stock, convertible adjustable preferred stock, remarketed preferred stock, single point adjustable rate stock, state rate auction preferred stock, variable cumulative preferred stock, adjustable rate convertible debt, convertible exchangeable preferred stock, convertible reset debentures, debt with mandatory common stock purchase contracts, exchangeable preferred stock, synthetic convertible debt, zero coupon convertible debt, puttable common stock.

At step 103, received data is filtered to remove data which may be unreliable. As an example, consider a large-scale study of realized volatilities and noise auto-covariances for S&P 1500 index constituents from Jan. 1, 1996, to Dec. 31, 2016. There are approximately 1,500 tickers every day, and over 3,500 tickers in total due to changes in the index constituents. Data relating to trades and quotes of all equities was collected at a high frequency (e.g., a millisecond after Jan. 1, 2007, and a microsecond from Jul. 27, 2015) from the TAQ database. Next, trades and quotes with special condition codes, as well as those that occur outside regular trading hours, were removed. National Best Bid and Offer (NBBO) data was constructed using quotes from all exchanges at a 1-second frequency. Trades with NBBOs were matched by their recorded time points and those trades that are outside the range of the corresponding NBBOs were removed. Redundant trades were then removed, retaining only non-zero returns. This helps alleviate model misspecification due to, for example, the effect of rounding, latency or delay across exchanges, and so on. Because this approach allows for general sampling schemes, removing zeros only results in a small cost of efficiency. Finally, any stock days that have less than 12 observations after cleaning were removed.

At step 104, an estimation/sampling interval can be selected, e.g., manually by a user or automatically by the system. The intervals at which security transaction price data can be sampled can be random or uniform. Also, there may be ambiguity in the duration of the sampling interval. According to one embodiment, a desired minimum change in intra-period price of the underlying security is selected to use as an estimation interval. It is at each of these estimation intervals, i.e., the time between two observations of a price, that inventive concepts utilize information to execute steps described herein. The selected estimation intervals can remain the same throughout the period. For determining an underlying security's movement through an interval, price can be defined as the bid price, if the underlying security price increases, or the ask price, if the underlying security decreases.

At step 105, a volatility estimator is constructed. According to a preferred embodiment, the estimator is constructed based on the assumption that a transaction price of a security comprises the sum of (1) a latent efficient security price that follows a general Itô semimartingale, and (2) a market microstructure noise component that follows a discrete-time moving-average (MA)(∞) associated with the random execution of trades. The estimator is obtained by maximizing the likelihood of a mis-specified moving-average (MA) model of returns with homoscedastic innovations.

At step 106, volatility and noise estimates are obtained. According to a preferred embodiment, this is performed using a Quasi-Maximum Likelihood Estimator (QMLE), where the logarithm of the efficient equilibrium security price is treated as a Brownian motion with constant volatility. According to such an embodiment, the QMLE is expressed as:

dXₜ=σdWₜ; Uᵢ=iθ(B)_{ε}_{ᵢ}, with θ(x)=1Σⱼ₌₁^{q}θⱼx^{j}, and εᵢ˜ [symbol] (0,1).

Further, exact quasi-likelihood estimates of \hat{X}²(q) and \hat{Ø}(q)ⱼ, for 1≤j≤q+1, can be estimated using the state-space representation of equation (19), where q is either determined by minimizing the AIC or BIC as defined in equation (10) or is pre-specified as described herein.

At step 107, based on the estimates obtained at step 106, a user or the system is instructed to take one or more actions. These instructions can be communicated as part of an interactive tool.

### Quasi-Maximum Likelihood Estimator (QMLE) and Moving-Average (MA) Model Selection

As discussed with respect to FIG. 1, a QMLE is utilized to estimate volatility and noise. In that regard, embodiments can utilize a Quasi-Maximum Likelihood Estimator (QMLE) that relies upon a mis-specified parametric model, for which the likelihood function is available:

dXₜ=σdWₜ;Uᵢ=ιθ(B)εᵢ,with θ(x)=1+Σⱼ₌₁^{q}θⱼx^{j}, and εᵢ˜ [symbol] (0,1).

In other words, it is assumed that the efficient price (in logarithm) is a Brownian motion with constant volatility but no drift, and that the noise follows a Gaussian MA(q) model, where the order q is to be determined. Under this model, the observed log-return vector Yn=(Y_{n,1}, Y_{n,2}, . . . , Y_{n,n}_{_{T}})^{T}, which is defined as:

Y_{n,1}=Xₜ_{ᵢ}−Xₜ_{ᵢ₋₁}+Uᵢ−Uᵢ₋₁,1≤i≤n_{T} (4)

follows a reduced-form Gaussian MA(q+1) model. The n_{T}× n_{T} covariance matrix Σn is given by:

$${\sum }_{n} ( {σ}^{2} , {ι}^{2} , θ ) = {\sum }_{n} ( {σ}^{2} , γ ) = {σ}^{2} {Δ}_{n} {n}_{} + {\sum }_{h = 0}^{{n}_{T} - 1} ( 2 {γ}_{h} - {γ}_{h + 1} - {γ}_{h - 1} ) {n}_{h}^{} \qquad ( 5 )$$

where ( [symbol] ₙ)ᵢⱼ=δ_{i,j}, ( [symbol] ₙ^{h})ᵢⱼ=δ_{h,|i-j|}, and γₕ is the h-th order auto-covariance:

$${γ}_{h} = \frac{{ι}^{2}}{2 π} {\int }_{- π}^{π} g ( λ \text{;} θ ) {λ h}^{} d λ , \qquad ( 6 )$$

where g(λ;θ)=|θ( [symbol] )|² is the scaled spectral density of U.

The QMLE (\hat{σ}ₙ²(q),\hat{ι}ₙ²(q), \hat{θ}n(q)) is thereby defined as the maximizer of the quasi log-likelihood:

Lₙ(σ₂,ι₂,θ)=−½ log det(Σₙ(σ²,ι²,θ))−½tr(Σₙ(σ²,ι²,θ)⁻¹YₙYₙ^{T}) (7)

where parameters take values in Π(q):

$$\prod ( q ) = \{ ( {σ}^{2} , {ι}^{2} , θ ) \text{:} \frac{1}{K} \leq {σ}^{2} \leq K \text{;} \frac{1}{K} \leq {ι}^{2} \leq K \text{;} θ ∈ Θ ( q ) . \} , \\ and \\ Θ ( q ) = \{ θ ∈ Θ ( ∞ ) \text{:} {θ}_{j} = 0 , {∀}_{j} > q . \} .$$

For convenience, θ∈Θ(q) is identified as a q-dimensional vector, ignoring all 0s beyond the qth entry of [theta], when no ambiguity exists. Also, by convention Θ(q)=Ø if q≤0.

To determine an appropriate order of q, either AIC or BIC can be used, which can be expressed as:

$$\begin{matrix}{AIC}_{n} ( q ) = 2 q - 2 {max}_{( {σ}^{2} , {ι}^{2} , θ ) ∈ \prod ( q )} {L}_{n} ( {σ}^{2} , {ι}^{2} , θ ) , & ( 8 ) \\ {BIC}_{n} ( q ) = q log {n}_{T} - 2 {max}_{( {σ}^{2} , {ι}^{2} , θ ) ∈ \prod ( q )} {L}_{n} ( {σ}^{2} , {ι}^{2} , θ ) . & ( 9 )\end{matrix}$$

q is selected by minimizing AIC or BIC:

$${\hat{q}}_{n , 1} = arg {min}_{q \leq {{n}^{1 \text{/} 2} ( log n )}^{- 1}} {AIC}_{n} ( q ) , {\hat{q}}_{n , 2} = arg {min}_{q \leq {{n}^{1 \text{/} 2} ( log n )}^{- 1}} {BIC}_{n} ( q ) \qquad ( 10 )$$

The corresponding likelihood estimators are denoted as AIC-QMLE and BIC-QMLE, respectively. The upper bound on q precludes MA models with too many parameters for estimation. In practice, it is not restrictive because for almost all evaluated stock-day pairs discussed herein, the selected orders are less than 10 using AIC or less than 6 using BIC.

### Theoretical Results

In discussion results achieved by described embodiments, it is assumed the noise follows an exact MA(q) model with some unknown q, so that its data generating process (DGP) is characterized by a finite-dimensional parameter θ∈Θ(q).

As discussed herein, embodiments allows for selection of different models. First, consider model selection using BIC according to the following discussion.

Proposition 1: Suppose Assumptions 1 and 2 are true. Suppose, in addition, Assumption 3 holds with ιⁿ=ι*∈[K⁻¹, K], θⁿ=θ*∈Θ(q*)\Θ(q*−1), for some fixed q*≥0. Then it holds

$${lim}_{n \to ∞} P ( {\hat{q}}_{n , 2} = {q}^{*} ) = 1$$

Then the likelihood estimator effectively minimizes the Kullback-Leibler divergence, only when the selected order is no smaller than the truth. Moreover, BIC imposes just large enough penalty to rule out orders that are greater than the truth asymptotically. The combination of these two results leads to the desired consistency in model selection.

Next, embodiments prove the (point-wise) central limit theorem for estimators of all parameters:

Theorem 1: Suppose the same assumptions as those in Proposition 1 are true; then it holds that

$$( \begin{matrix}{n}^{1 \text{/} 2} ( {\hat{ι}}_{n}^{2} ( {\hat{q}}_{n , 2} ) - {( {ι}^{*} )}^{2} ) \\ {n}^{1 \text{/} 2} ( {\hat{θ}}_{n} ( {\hat{q}}_{n , 2} ) - {θ}^{*} ) \\ {n}^{1 \text{/} 4} ( {\hat{σ}}_{n}^{2} ( {\hat{q}}_{n , 2} ) - {C}_{T} )\end{matrix} ) {\to }^{ℒ - s} ( {0}_{{q}^{*} + 2} , ( \begin{matrix}{( {ι}^{*} )}^{4} ( 2 + {cum}_{4} [ ɛ ] ) & {0}_{{q}^{*}}^{T} & 0 \\ {0}_{{q}^{*}} & {W}^{- 1} ( {θ}^{*} ) & {0}_{{q}^{*}} \\ 0 & {0}_{{q}^{*}}^{T} & {AVAR}_{1}\end{matrix} ) )$$

where cum4[ε] denotes the fourth cumulant of ε, C_{T}:=C(2)_{T},

$${C ( p )}_{T} = \frac{1}{T} {\int }_{0}^{T} {σ}_{s}^{p} ds , W ( θ ) = \frac{1}{4 π} {\int }_{- π}^{π} \frac{\partial log g ( λ \text{;} θ )}{\partial θ} {( \frac{\partial log g ( λ \text{;} θ )}{\partial θ} )}^{T} d λ , \\ {AVAR}_{1} = \frac{{ζ}^{*}}{{T}^{1 \text{/} 2}} ( 5 {C ( 4 )}_{T} {C}_{T}^{1 \text{/} 2} + 3 {C}_{T}^{3 \text{/} 2} ) , and {ζ}^{*} = {{ι}^{*} ( g ( 0 \text{;} {θ}^{*} ) )}^{1 \text{/} 2}$$

Proposition 1 implies that \hat{θ}n(\hat{q}_{n,2}) is a q-dimensional vector, with probability approaching 1, so is \hat{θ}n(\hat{q}_{n,2})−θ* in this regard. The volatility estimator is consistent with respect to the quadratic variation in spite of model misspecification, and it achieves the same rate of convergence as that in the white-noise setting. The noise parameters are also consistent. Moreover, in case the true DGP of ε is Gaussian, \hat{ι}ₙ²(\hat{q}_{n,2}), \hat{θ}ₙ(\hat{q}_{n,2})) are semiparametrically efficient because their asymptotic covariance matrix coincides with that of the MLE of {Uⱼ}ⱼⁿ=1

Embodiments propose estimators of auto-covariances and auto-correlations of the noise as by-products:

$$\begin{matrix}{\hat{γ}}_{n} ( {\hat{q}}_{n 𝒥} ) h = \frac{{\hat{ι}}^{2} ( {\hat{q}}_{n 𝒥} )}{{2}_{x}} {\int }_{- x}^{z} g ( λ \text{;} \hat{θ} n ) ( {\hat{q}}_{n 𝒥} ) ) {e}^{ι λ h} d λ , 0 \leq h \leq {\hat{q}}_{n 𝒥} , & ( 11 ) \\ {\hat{ρ}}_{n} ( {\hat{γ}}_{n 𝒥} ) h = \frac{{\hat{γ}}_{n} ( {\hat{q}}_{n 𝒥} ) h}{{\hat{γ}}_{n} ( {\hat{q}}_{n 𝒥} ) {o}^{′}} 1 \leq h \leq {\hat{q}}_{n 𝒥} & ( 12 )\end{matrix}$$

The estimates are zero (0) beyond the \hat{q}_{nJ} ^{th} lag.
The next corollary presents the point-wise central limit results when using BIC:
Corollary 1: Suppose the same assumption as those in Proposition 1 are true: Let γ^{★} be the (γ^{★}+1) vector of the up-to-qth-order auto-covariances of U. Let p^{★}=γ₀^{★}^{^{−1}}(γ₁^{★}, γ₂^{★}, . . . , γ_{q}^{★}) be the q-vector of up-to-qth-order auto-correlations of U. Then it holds:

$${n}^{1 \text{/} 2} ( {\hat{γ}}_{n} ( {\hat{q}}_{n , 2} ) - {γ}^{★} ) {\to }^{ℒ} ( 0 , {AVAR}_{2} ) , with , {AVAR}_{2} = 2 {W ( {γ}^{★} )}^{- 1} + {γ}^{★} {γ}^{{★}^{T}} {cum}_{1} [ ɛ ]$$

$${n}^{1 \text{/} 2} ( {\hat{p}}_{n} ( {\hat{q}}_{n , 2} ) - {p}^{★} ) {\to }^{ℒ} ( 0 , {AVAR}_{3} ) , with the ijth entry of the {q}^{★} \times {q}^{★} matrix {AVAR}_{3} given by {( {AVAR}_{3} )}_{ij} = \frac{{p}_{i}^{★} {p}_{j}^{★}}{{γ}_{0}^{{2}_{★}}} {( {AVAR}_{2} )}_{11} + \frac{1}{{γ}_{0}^{{2}_{★}}} {( {AVAR}_{2} )}_{i + 1 , j + 1} - \frac{{p}_{i}^{★}}{{γ}_{0}^{{2}_{★}}} {( {AVAR}_{2} )}_{1 , j + 1} - \frac{{p}_{j}^{★}}{{γ}_{0}^{{2}_{★}}} {( {AVAR}_{2} )}_{1 , j + 1}$$

$$where$$

$$W ( γ ) = \frac{1}{2 π} = \frac{1}{2 π} {\int }_{- π}^{π} \frac{\partial log f ( λ \text{;} γ )}{\partial γ} {( \frac{\partial log f ( λ \text{;} γ )}{\partial γ} )}^{T} \partial γ$$

and f is the spectral density of U, given explicitly by

f(λ;γ)=ι²g(λ;θ)=Σ_{|h|≤q}γ|h|^{e}^{^{iλh}} (13)

Embodiments can also construct similar estimators based on AIC, even though order selection by AIC is inconsistent. In fact, AIC tends to select a more complicated model that nests the true one, so that estimators of noise parameters using AIC are also consistent, despite not being efficient. By contrast, as embodiments show later, AIC- and BIC-QMLE of volatility share the same asymptotic distribution. Neither estimator is, however, minimax efficient.

Embodiments also analyze the minimax efficiency bound of volatility estimation from noisy returns. One approach relies on Le Cam's concept of asymptotic equivalence between experiments. Two sequences of statistical experiments (εₙ⁽⁰⁾, εₙ⁽¹⁾) are asymptotically equivalent if their Le Cam distance Δ_{LC}(εₙ⁽⁰⁾, εₙ⁽¹⁾) vanishes asymptotically. Using this approach, the minimax efficiency bound of volatility estimation can be established, which is T^{-3/2}^{_{ι}}∫₀^{T}σₜ³ dt, in the case of i.i.d. Gaussian noise. Embodiments use this result to establish the minimax bound in the presence of an MA(q) noise.

Considering the following definitions is instructive:

### Definition 1:

Let εₙ⁽⁰⁾=εₙ⁽⁰⁾(α, ι², θ) be the statistical experiment generated by observing {Y_{n,j}}ⱼ₌₁^{nT} from the foregoing discussion under Assumption 2, with volatility σₜ³ being α-Holder continuous, independent of Xₜ, and satisfying min_{tε[0,T]σ}_{_{ι}}² ∧σₜ⁻²≥K⁻¹.
Let εₙ⁽¹⁾=εₙ⁽¹⁾(α,α²) be another statistical experiment generated by observing ^{t}{Y_{n,j}}ⱼ₌₁^{nT} from the foregoing discussion under Assumption 2, where Uⱼ is i.i.d. centered Gaussian with variance α², and σ_{ι}² is α-H^{..} older continuous, independent of Xₜ, and satisfies min_{t∈[0,T]}σ_{ι}² ∧σₜ⁻²≥K⁻¹.
As seen, definition 1 imposes independence between X and σ².

Then, it can be observed from Theorem 1 that the asymptotic variance of QMLE with dependent noise coincides with that in a white-noise case, except that ι² in the latter is replaced by the long-run variance of the dependent noise, i.e., ζ²=ι²(1+Σⱼ^{q}=1^{θ}j)². Therefore, θ appears in the asymptotic variance only through ζ. This finding leads to conjecture that, in terms of volatility estimation, εₙ⁽⁰⁾ provides the same information as εₙ⁽¹⁾, as long as their noise processes have the same long-run variance. Indeed, the following theorem can be proven:

Theorem 2: For any ∝>¼ and θ∈⊖(q) for some fixed q, the experiments εₙ⁽⁰⁾ and εₙ⁽¹⁾ with a²=ζ² are asymptotically equivalent. More precisely, their Le Cam distance satisfies that Δ_{LC} (εₙ⁽⁰⁾(∝,σ²,i²,θ), εₙ⁽¹⁾(∝,σ²,a²))≤n^{-1/4}+n^{1/4-∝}(log n)^{2∝} Consequently, the minimax efficiency bound for volatility estimation is given by 8T^{-3/2}ζ∫₀^{T}σₛ³ds.

### Uniform Post-Selection Inference on Volatility

It should be appreciated that the point-wise asymptotic theory relies on an unrealistic result of perfect model selection (Proposition 1), which provides a misleading picture of the actual finite sample performance of the estimator. In the classic time-series setting, conducting uniformly valid post-selection inference on parameters over a non-trivially large class of DGPs is generally impossible. However, for volatility estimation, its convergence rate is as slow as n^{1/4}, so model selection mistakes are potentially negligible for a wide class of DGPs. As discussed, described embodiments can develop a uniformly valid inference for volatility.

Embodiments first define a class of DGPs over which uniformity is to be established. The inference allows for an (MA)(∞) noise, for which model selection mistakes as a result of AIC and BIC are inevitable in any sample.

Condition 1: {(Uⱼ}ⱼ^{∞}=0 are random variables defined on the probability space (Ω, F, P). P is such that {Uⱼ}ⱼⁿ^{_{T}}=0 obeys Assumption 3 and

$$\frac{1}{K} \leq {i}^{( n )} , \begin{matrix}min \\ q \geq 0\end{matrix} ( {qn}^{- 1} + {\sum }_{j \geq q + 1} {\vert {θ}_{j}^{( n )} \vert}^{2} ) \leq {{Kn}^{- \frac{3}{4}} ( log n )}^{- 1} .$$

Condition 1 imposes a uniform lower bound on noise because uniformity is not possible over a vanishing noise while allowing for model selection uncertainty, which is established in Proposition 2 below. In addition, uniformity requires the existence of an appropriate order q that controls model overfitting and model misspecification error. The first term qn⁻¹ is related to the estimation error of q parameters, whereas the second term Σ_{j≥q+1}|θⱼ⁽ⁿ⁾|² is related to the error of approximating the (MA)(∞) DGP with an MA(q) model. This bound ensures the selected MA model is not overly complicated yet is sufficiently rich to approximate the DGP. It is easy to show that Condition 1 holds, for example, for all stationary ARMA(p,q) models with fixed parameters.
With respect to this class of models, embodiments establish the uniformity result:
Theorem 3: Let {P⁽ⁿ⁾} be a sequence of DGPs under which Assumptions 1-2 hold. Suppose for each n Condition 1 holds for P=P⁽ⁿ⁾). Then for jϵ(1, 2) embodiments have

$${( {ζ}^{( n )} )}^{- \frac{1}{2}} {Δ}_{n}^{- \frac{1}{2}} ( {\hat{σ}}_{n}^{2} ( {\hat{q}}_{n , j} ) - {C}_{T} ) {\to }^{ℒ - 8} ( 0 , \frac{1}{T} ( 5 {C ( 4 )}_{T} {C}_{T}^{- \frac{1}{2}} + 3 {C}_{T}^{\frac{3}{2}} ) )$$

where (ζ⁽ⁿ⁾)² is the long-run variance of the (MA)(∞) process, that is, (ζ⁽ⁿ⁾)²=(ι⁽ⁿ⁾)²g(0;θ⁽ⁿ⁾).

The next corollary provides a uniformly valid confidence interval for volatility, which requires a consistent estimator of the asymptotic variance to be introduced herein.

Corollary 2: Suppose Assumptions 1-2 hold. Let [symbol] ⁽ⁿ⁾ be the collection of all DGPs for which Condition 1 holds for a given n, and let [symbol] =∩ₙ≥ₙ_{₀} [symbol] ⁽ⁿ⁾ be the collection of DGPs for which Condition 1 holds for all n≥n₀. Let c(1−a)=F⁻¹(1−∝/2), where F(⋅) is the standard Gaussian cumulative distribution function. The confidence interval based on \hat{σ}_{N}²(\hat{q}) with \hat{q}ϵ{\hat{q}ₙ, 1, \hat{q}ₙ, 2} is uniformly valid in P∈ [symbol] :

$${lim sup}_{n \to {∞}_{P ϵ ℙ}} \vert P ( {C}_{T} ∈ {CI}_{n} ( ∝ ) ) - ( 1 - ∝ ) \vert = 0 where$$

$${CI}_{n} ( ∝ ) = [ {\hat{σ}}_{n}^{2} ( \hat{q} ) \pm c ( 1 - ∝ ) {( {\hat{ζ}}_{n}^{2} ( \hat{q} ) {Δ}_{n} )}^{\frac{1}{4}} \sqrt{\frac{1}{T} ( 5 {{\hat{C}}_{n} ( 4 )}_{T} {{\hat{σ}}_{n}^{2} ( \hat{q} )}^{- \frac{1}{2}} + 3 {{\hat{σ}}_{n}^{2} ( \hat{q} )}^{\frac{3}{2}} )} ] with \\ {\hat{ζ}}_{n}^{2} ( \hat{q} ) = {\hat{ι}}_{n}^{2} ( \hat{q} ) g ( 0 ; {\hat{θ}}_{n} ( \hat{q} ) ) and {{\hat{C}}_{n} ( 4 )}_{T} .$$

The uniformity result demonstrates the robustness of the volatility inference with respect to the choice of q. Barring the selection of q, the volatility estimator is tuning-free, which makes it particularly attractive for empirical applications.

In practice, the assumption that noise is absent for returns subsampled at a certain frequency is common. However, in many cases, the confidence interval based on the realized volatility is narrower than that of the efficient noise-robust estimator with full data, which indicates the noiseless assumption that realized volatility relies on is unreliable for inference. More specifically, this issue occurs if the long-run variance of the noise is not so small relative to the sample size:

$${ζ}^{2} > {m}^{2} {{Δ}_{n} ( \frac{{C ( 4 )}_{T}}{4 {C ( 3 )}_{T}} )}^{2} ,$$

where m is the ratio of the number of observations in the full sample to that in the subsample.

Using noise-robust estimators, such as pre-averaging and realized kernel estimators, might be safer for inference in all scenarios, but these estimators converge at an n¹⁴ rate and hence are not efficient, in particular when noise is too small to be detected relative to the sample size. By contrast, the convergence rate of the QMLE improves from n¹⁴ to n¹² as the magnitude of the noise decreases, and reaches the optimal n¹² rate when noise vanishes. When noise disappears, an efficiency loss in QMLE occurs up to a constant factor compared to the realized volatility estimator, due to ignorance of this knowledge. Although the magnitude of the noise matters for different asymptotic behaviors, embodiments develop a uniformly valid inference without requiring the knowledge of the magnitude.

If noise is small, θ is weakly identified. If it diminishes, θ is unidentified. Because θ is a nuisance for volatility estimation, embodiments reparametrize the QMLE in terms of strongly identified parameters (_2;), where is a vector of the auto-covariances of the noise. That is, embodiments rewrite the quasi log-likelihood in terms of (σ²,γ), where y is a vector of the auto-covariances of the noise. The quasi log-likelihood in terms of (σ², γ) is:

Lₙ(σ²,γ)=−½ log det(Σₙ(σ²,γ))−½tr(Σₙ(σ²,)⁻¹YₙYₙ^{T}) (14)

and define \hat{σ}ₙ²(q), Ŷₙ(q) as its maximizer. The parameter space of (σ², γ) can be derived from that of (σ²,ι²,θ).

Nonetheless, it has been shown for a white-noise case that as true noise variance vanishes, its estimator will hit the boundary of the parameter space, so that the asymptotic distribution of the volatility estimator becomes non-standard. A similar issue occurs here when noise is minimal. In other words, for certain values of bn(q), the spectral density of U given by equation (13) can hit zero for certain values of λ, and hence a solution may not exist such that \hat{ι}ₙ²(q) is positive and \hat{θ}ₙ(q) is a real vector.

Embodiments adopt a larger parameter space IIₙ^{σ}^{²}^{,γ}(q), which is of the form: Πₙ^{(σ}^{²}^{,γ)}(q)={(σ²,γ): Δₙ⁻¹Σₙ(σ²,γ)≥K⁻¹ [symbol] ₙ; ∥γ∥≤K; γⱼ=0, ∀>q} where Σₙ(σ², γ) is defined in equation (5), which essentially only requires Σₙ(σ²,γ) (after some scaling) to be asymptotically non-negative. By enlarging the parameter space embodiments avoid the potential boundary constraints due to its relationship with ι², θ, so embodiments achieve the desired asymptotic normality for volatility estimation.

More notation is needed to characterize the asymptotic variance in this case, which will work regardless of the magnitude of the noise. For any positive reals σ² and δ,γϵ [symbol] ^{q+1} with some fixed integer q, and Q, c ϵ [symbol] embodiments define

AVAR(σ²,γ,δ,Q,c)=1/T((σ²,γ,δ)⁻¹\tilde{W}(σ²,γ,δ,Q,c)W(σ²,γ,δ)⁻¹)₁₁,

where the subscript 11 denotes the (1,1)-entry of the matrix, and W(σ²,γ,δ), \tilde{W}(σ²,γ,δ,Q,c) are (q+2)×(q+2) dimensional matrices, defined respectively as

$$W ( {σ}^{2} , γ , δ ) = \frac{1}{2 π} {\int }_{- π}^{π} \frac{\partial log f ( λ ; {σ}^{2} , γ , δ )}{\partial ( {σ}^{2} , γ )} {( \frac{\partial log f ( λ ; {σ}^{2} , γ , δ )}{\partial ( {σ}^{2} , γ )} )}^{T} d λ \\ \tilde{W} ( {σ}^{2} , γ , δ , Q , c ) = 2 W ( {σ}^{2} , γ , δ ) + \frac{Q {δ}^{2}}{π} {\int }_{- π}^{π} \frac{\partial {( f ( λ ; {σ}^{2} , γ , δ ) )}^{- 1}}{\partial ( {σ}^{2} , γ )} {( \frac{\partial {( f ( λ ; {σ}^{2} , γ , δ ) )}^{- 1}}{\partial ( {σ}^{2} , γ )} )}^{T} d λ + c ( \frac{1}{2 π} {\int }_{- π}^{π} \frac{\partial {( f ( λ ; {σ}^{2} , γ , δ ) )}^{- 1}}{\partial ( {σ}^{2} , γ )} ( f ( λ ; {σ}^{2} , γ , δ ) - {σ}^{2} δ ) d λ ) \times {( \frac{1}{2 π} {\int }_{- π}^{π} \frac{\partial {( f ( λ ; {σ}^{2} , γ , δ ) )}^{- 1}}{\partial ( {σ}^{2} , γ )} ( f ( λ ; {σ}^{2} , γ , δ ) - {σ}^{2} δ ) d λ )}^{T} where \\ f ( λ ; {σ}^{2} , γ , δ ) = {σ}^{2} δ + {\vert 1 = {e}^{ λ} \vert}^{2} {\sum }_{j = - q}^{q} γ \vert j \vert {e}^{ j λ} \qquad ( 15 )$$

Embodiments first provide asymptotic distributions of σₙ²(q) under different drifting sequences of (ι⁽ⁿ⁾)².

Theorem 4: Let Assumptions 1-3 hold. For θⱼ⁽ⁿ⁾→θⱼ^{★} and any fixed positive integer q that satisfies Δₙ^{1/2} Σ_{j=q}^{∞}|θⱼ⁽ⁿ⁾|→0, then

$$\begin{matrix}Under {{Δ}_{n}^{- 1} ( {ι}^{( n )} )}^{2} \to {∞ ( {( {ς}^{( n )} )}^{2} {Δ}_{n} )}^{- 1 / 4} ( {\hat{σ}}_{n}^{2} ( q ) - {C}_{T} ) {\to }^{ℒ - s } ( 0 , \frac{1}{T} ( 5 {C}_{T}^{- 1 / 2} {C ( 4 )}_{T} + 3 {C}_{T}^{3 / 2} ) ) & ( i ) \\ Under {{Δ}_{n}^{- 1} ( {ι}^{( n )} )}^{2} \to 0 {Δ}_{n}^{- 1 / 2} ( {σ}_{n}^{2} ( q ) - {C}_{T} ) {\to }^{ℒ - s } ( 0 , \frac{1}{T} ( 4 q + 6 ) {C ( 4 )}_{T} ) & ( ii ) \\ Under {{Δ}_{n}^{- 1} ( {ι}^{( n )} )}^{2} \to {a}^{2} ϵ ( 0 , ∞ ) , writing {γ}^{★} ϵ {q + 1}^{} where for \\ {γ}_{j}^{★} = {a}^{2} {\sum }_{l = 0}^{q - j} {θ}_{l}^{★} {θ}_{l + j}^{★} for 0 \leq j \leq q \\ {Δ}_{n}^{- 1 / 2} ( {\hat{σ}}_{n}^{2} ( q ) - {C}_{T} ) {\to }^{ℒ - s } ( 0 , AVAR ( {C}_{T} , {γ}^{★} , 1 , {C ( 4 )}_{T} - {C}_{T}^{2} , {cum}_{4} [ ϵ ] ) ) & ( iii )\end{matrix}$$

In scenario (i), the convergence rate varies within (n^{1/4},n^{1/2}), depending on the long-run variance of the noise. Scenario (ii) is a special case of (iii) with a²=0. This case is highlighted because its asymptotic variance is explicitly comparable to that of the realized volatility estimator. Indeed, the relative asymptotic efficiency ratio between the two estimators is (4q+6)/2=2q+3>1, which may result in a substantial efficiency loss if an overly complicated likelihood (large q) is adopted.

To give some intuition behind the asymptotic variance in scenario (iii), note that all entries of Σₙ(σ²,γ) are of the same order O(Δₙ), so that the entries of Δₙ⁻¹Σₙ(σ²,γ) no longer depend on n, and the in-fill asymptotic setting becomes very similar to the classic case, from where the new asymptotic variance formula is motivated.

Concretely, the matrix W(σ²,γ,δ) corresponds to the probability limit of the Hessian matrix of the log-likelihood, whereas the matrix \tilde{W}(σ²,γ,δ, Q, c) originates from the asymptotic covariance matrix of the score vector. W depends only on the second moments of the data, whereas \tilde{W} also involves the fourth moments (the quarticity C(4)_{T} and the fourth cumulant cum₄ [ϵ]). The following models establish uniformly valid inference.

Condition 2: {Uⱼ}ⱼ₌₀^{∞} are random variables defined on the probability space (Ω, [symbol] , P). P is such that {Uⱼ}ⱼ₌₀ⁿ^{_{T}} obeys Assumption 3. In addition, a fixed positive integer q exists such that Δₙ^{1/2} Σⱼ₌₀^{∞}|θⱼ⁽ⁿ⁾|→0.

Condition 2 differs from Condition 1 in that the class of models allowed here must be well approximated by an MA(q) and q is known and fixed, so that model selection is not needed. As mentioned, building a uniformly valid interval allowing for both small noises and model selection is impossible. An “impossibility” is presented below:

Consider a small-noise setting with (i⁽ⁿ⁾)²=O(Δₙ). As Theorem 4 shows, in this case, the volatility estimator has an n^{1/2} convergence rate. Moreover, it is assumed the noise process has no auto-correlation beyond the first lag so that selecting q from {0,1}. It is sufficient to study the cumulative distribution function:

Gₙⱼ(x)=P(n^{1/2}(\hat{σ}ₙ²(\hat{q}ₙⱼ∧1)−C_{T})≤x)

The next proposition demonstrates that even with constant volatility, no uniformly consistent estimator of G_{n,j}(x) exists in this scenario:

Proposition 2: For each n, let [symbol] ⁽ⁿ⁾ be the collection of all DGPs under which Assumptions 1 and 2 hold with σₜ² C_{T} or some C_{T} fixed and all t∈[0, T]{Uⱼ}ⱼ₌₀ⁿ^{_{T}}, and {Uⱼ}ⱼ₌₀ⁿ^{_{T}} obeys Assumption 3 with Δₙ⁻¹^{_{ι}}⁽ⁿ⁾≤K. Then it holds that, for each x∈ [symbol] and j∈{1,2},

$${lim inf}_{n \to ∞} {lim}_{{\hat{G}}_{n , j ( x )}} {sup}_{P ∈ ℙ} P ( \vert {\hat{G}}_{n , j} ( x ) - {G}_{n , j} ( x ) \vert > \frac{1}{K} ) > 0$$

where the infimum extends over all estimators Ĝ_{n,j}(x) of G_{n,j}(x).

This result, nonetheless, may have little effect on the empirical application of disclosed estimators except for some efficiency loss, because for returns of the S&P 1500 index constituents studied, the selected orders rarely exceed 10. Most estimates are smaller than 6. So embodiments allow a user to choose a q greater than 10, say, 12.

### Implementation

To further explain the inventive concepts, implementation of the QMLE is discussed in detail. Directly calculating the inverse of En would be computationally expensive, when evaluating the likelihood function at each stage of an optimization routine. To avoid this problem, the classic time-series literature adopts an approximation approach, which as discussed below, is improved upon by described embodiments.

A former approximation approach, known as the Whittle estimator (\hat{σ}_{w,n}²(q),\hat{γ}_{w,n}²(q)) is constructed as the maximizer of an approximate likelihood:

L_{w,n}(σ²,γ)=−½ log det V_{w,n}−½tr(Ω_{w,n}⁻¹YₙYₙ^{T}), where Ω_{w,n}=O_{w,n}V_{w,n}O_{w,n}^{†}, (17)

where O_{w,n} is an n×n unitary matrix with

$${( {O}_{w , n} )}_{j k} = \frac{1}{\sqrt{n}} exp ( - \frac{2 π}{n} j , k ) ,$$

and V_{w,n} is an n×n diagonal matrix:

$${{V}_{w , n} ( {σ}^{2} , γ )}_{jk} = {δ}_{j , k} {\sum }_{h = - ∞}^{+ ∞} ( {σ}^{2} {Δ}_{n} {δ}_{h , 0} + ( 2 γ h - γ h + 1 - γ h - 1 ) ) exp ( - \frac{2 π}{n} h \cdot j ) , \qquad ( 18 )$$

with γ defined by (3.6). Because Ω_{w,n}⁻¹=O_{w,n}^{†}V_{w,n}⁻¹O_{w,n} and V_{w,n} is diagonal, evaluating L_{w,n}(σ², γ) is quite efficient.

Unfortunately, the next proposition shows the Whittle estimator of volatility is inconsistent in the in-fill asymptotic setting, even if the noise is i.i.d. Gaussian and the efficient price is a Brownian motion with constant volatility (hence, QMLE is in fact the MLE). An asymptotically non-negligible bias exists depending on the realizations of the noise process on the borders of the sampling window [0, T].

Proposition 3: Suppose some constant C_{T} exists such that the true DGP has σₜ²=C_{T} for all t∈[0,T], U_{j˜}^{i.i.d} [symbol] (0,t^{2★}), and q=0, then as n→∞,

\hat{σ}_{w,n}²=C_{T}+T⁻¹(U₀²+Uₙ²)

To visualize the difference between the exact QMLE described herein and the Whittle estimator, embodiments utilized their quadratic forms:

Proposition 4: Suppose the same assumptions as those in Proposition 1 hold. Let γ^{★} be the (q^{★}+1) vector of up-to-q^{★}th-order autocovariances of U. The QMLE \hat{σ}ₙ² (q^{★}) and the Whittle estimator \hat{σ}_{w,n}² (q^{★}) satisfy

$${\hat{σ}}_{n}^{2} ( {q}^{★} ) = {Y}_{n}^{T} {n}_{} ( {C}_{T ′} {γ}^{★} ) {γ}_{n} + {o}_{P} ( {n}^{- \frac{1}{4}} ) , \\ {\hat{σ}}_{w , n}^{2} ( {q}^{★} ) = {Y}_{n}^{T} {w , n}_{} ( {C}_{T} + {T}^{- 1} ( {U}_{0}^{2} + {U}_{n}^{2} ) , {γ}^{★} ) {Y}_{n} + {o}_{P} ( 1 ) ,$$

where the n_{T}× n_{T} weighting matrices Wₙ and W_{w,n} are defined by

$$v ec ( {n}_{} ( {σ}^{2} , γ ) ) = - \frac{1}{n} \frac{d vec ( {\sum }_{n} {( {σ}^{2} , γ )}^{- 1} )}{d ( {σ}^{2} , γ )} {W ( {σ}^{2} , γ , {Δ}_{n} )}^{- 1} ( 1 , {0}_{q + 1} ) , \\ vec ( {w , n}_{} ( {σ}^{2} , γ ) ) = - \frac{1}{n} \frac{d vec ( {{Ω}_{w , n} ( {σ}^{2} , γ )}^{- 1} )}{d ( {σ}^{2} , γ )} {W ( {σ}^{2} , γ , {Δ}_{n} )}^{- 1} ( 1 , {0}_{q + 1} ) ,$$

with Σₙ given by (3.5), Ω_{w,n} given by (5.17), and the (q+2)×(q+2) matrix W given by (4.15). Both [symbol] ₙ and [symbol] _{w,n} are homogeneous functions of degree zero in (σ², γ).

FIG. 1 is informative regarding the differences between [symbol] ₙ and [symbol] _{w,n}, in the i.i.d. noise case (q=0). Apparently, [symbol] _{w,n} deviates substantially from 0 as it approaches the borders, whereas [symbol] ₙ diminishes. The failure of the Whittle approximation highlights the impact of different asymptotic designs (long-span vs. in-fill) on the large sample behavior of the same estimator.

FIG. 1 also illustrates Wₙ in the case of MA(5) noise. Notable “flatness” is present on the top, which helps cancel out the impact of dependent noise. This pattern motivates us to investigate the connection between the QMLE and the flat-top realized kernel.

Proposition 5: Suppose the same assumptions as those in Proposition 1 hold. The QMLE \hat{σ}ₙ² (q^{★}) is asymptotically equivalent to an exponential-type flat-top realized kernel. More generally, for any fixed q≥0 and (σ²,γ)∈ [symbol] ^{q+2}, such that (3.6) holds for some (σ²,t²,θ)∈Π(q), for all n^{1/2+∝}≤i,j≤n−^{1/2+∝} with 0<a<½, the weighting matrix [symbol] ₙ(σ²,γ) satisfies:

$$\begin{matrix} {sup}_{- q - 1 \leq l \leq q + 1} \vert {n}_{} {( {σ}^{2} , γ )}_{i , i + l} - {n}_{} {( {σ}^{2} , γ )}_{ii} \vert = {o}_{P} ( {n}^{- 5 / 4} ) , & ( i ) \\ T \times {n}_{} {( {σ}^{2} , γ )}_{ij} = \{ \begin{matrix}1 + op ( {n}^{- 1 / 4} ) , & \vert j - i \vert \leq q + 1 ; \\ k ( \frac{\vert i - j \vert - q - 1}{{H}_{n}} ) ( 1 + {o}_{P} ( 1 ) ) , & \vert j - i \vert \geq q + 2 ,\end{matrix} & ( ii )\end{matrix}$$

where the implicit equivalent kernel is k(x)=(1+x)e^{-x}, and the corresponding bandwidth is Hₙ=ζσ⁻¹ Δₙ^{1/2} with ζ²=Σ_{|j|≤q}γ|j|.

Proposition 5 suggests the QMLE can be regarded as an iterative kernel estimator, with its bandwidth automatically selected. Compared to using this equivalent kernel representation, implementing the QMLE using an auxiliary model is more convenient, which embodiments discuss next.

Inventive concepts utilize an auxiliary reduced-form MA(q) model of observed noisy returns:

$${Y}_{n , i} = ( B ) {ϵ}_{i} , with \\ φ ( x ) = 1 + {\sum }_{j = 1}^{q + 1} {φ}_{j} {x}^{j} , 1 \leq i \leq n , ϵ ∼ ( 0 , {x}^{2} ) . \qquad ( 19 )$$

According to an embodiment, a method starts as follows:

1. Obtain exact quasi-likelihood estimates of \hat{X}² (q) and \hat{Ø}(q)ⱼ, for 1≤j≤q+1, using the state-space representation of equation (19), where q is either determined by minimizing the AIC or BIC as defined in equation (10) or is pre-specified as described herein.
2. Estimate volatility and the noise autocovariances using the above estimates:

$${\hat{σ}}_{n}^{2} ( q ) = {Δ}_{n}^{- 1} {\hat{x}}^{2} ( q ) {( 1 + {\sum }_{j = 1}^{q + 1} {\hat{φ} ( q )}_{j} )}^{2} , \\ {{\hat{γ}}_{n} ( q )}_{j} = \frac{1}{2 π} {\int }_{- π}^{π} \frac{{\hat{x}}^{2} ( q ) {e}^{i j λ}}{{\vert 1 - {e}^{ λ} \vert}^{2}} ( {\vert 1 + {\sum }_{l = 1}^{q + 1} {\hat{φ} ( q )}_{l} {e}^{ l λ} \vert}^{2} - {( 1 + {\sum }_{l = 1}^{q + 1} {\hat{σ} ( q )}_{l} )}^{2} ) d λ , 0 \leq j \leq q ,$$

which are obtained by comparing different parameterizations for the return autocovariances.
3. Solve q+1 nonlinear equations for q+1 model parameters (\hat{ι}²(q), \hat{θ}ₙ(q)) from \hat{γ}ₙ(q) obtained in Step 2:

$${{\hat{γ}}_{n} ( q )}_{j} = {\hat{ι}}_{n}^{2} ( q ) {\sum }_{l = 0}^{q - j} {{\hat{θ}}_{n} ( q )}_{l} {{\hat{θ}}_{n} ( q )}_{l + j} , 0 \leq j \leq q . \qquad ( 20 )$$

Effectively, step 3 is to find q+1 model parameters of the MA_{(q)} noise process from up-to-qth order autocovariances \hat{γ}ₙ(q)ⱼ, 0≤j≤q. This practice is common in the classic time-series analysis.

Note that Step 2 is sufficient for volatility and autocovariance estimation, which is rather simple. If one of skill in the art is interested in (ι²,θ), a unique solution (\hat{ι}²(q), \hat{θ}ₙ(q)) exists from Step 3, with probability approaching 1. However, when noise is small, these parameters are weakly identified, and equation (20) might have no solution such that \hat{ι}²(q) is positive and \hat{θ}ₙ(q) is a real vector. Studying the inference of (ι²,θ) in this case might be interesting, but a primary interest here is estimating volatility, whose inference in step 3 does not affect.

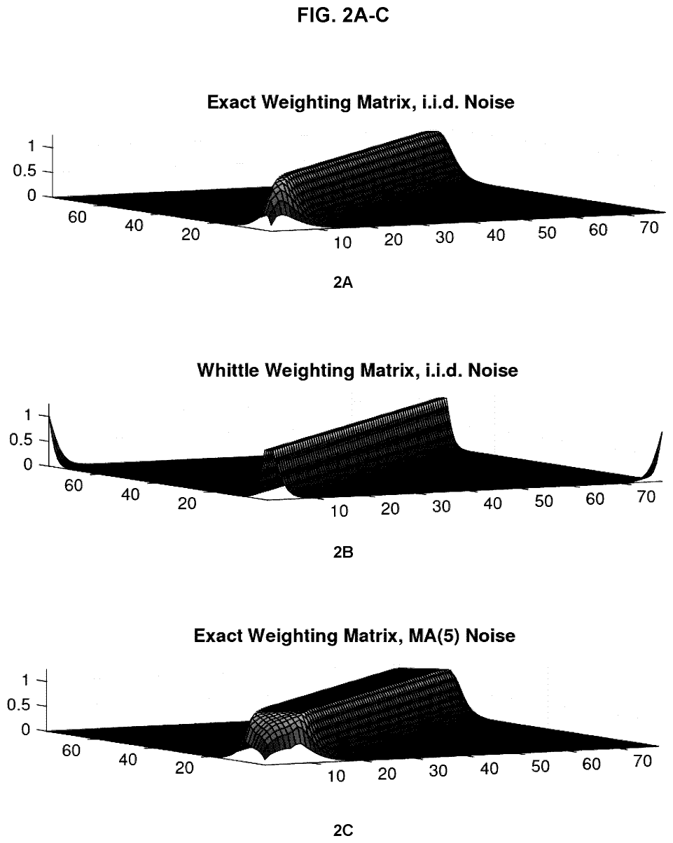

FIG. 2 shows quadratic representations of different estimators. Generally, FIGS. 2A-2C illustrate the weighting matrices Ws in the quadratic representations of the QMLE and the Whittle approximation in the case of i.i.d. noise, as well as the weighting matrix of the QMLE with MA(5) noise. FIGS. 2A and 2B illustrate the differences between Wₙ (i.e., an exact weighing matrix) and W_{w,n} (i.e., a Whittle weighting matrix), respectively, in the i.i.d. noise case (q=0). As seen, W_{w,n} deviates substantially from 0 as it approaches the borders, whereas Wₙ diminishes. FIG. 2C illustrates Wₙ (i.e., an exact weighing matrix) in the case of MA(5) noise.

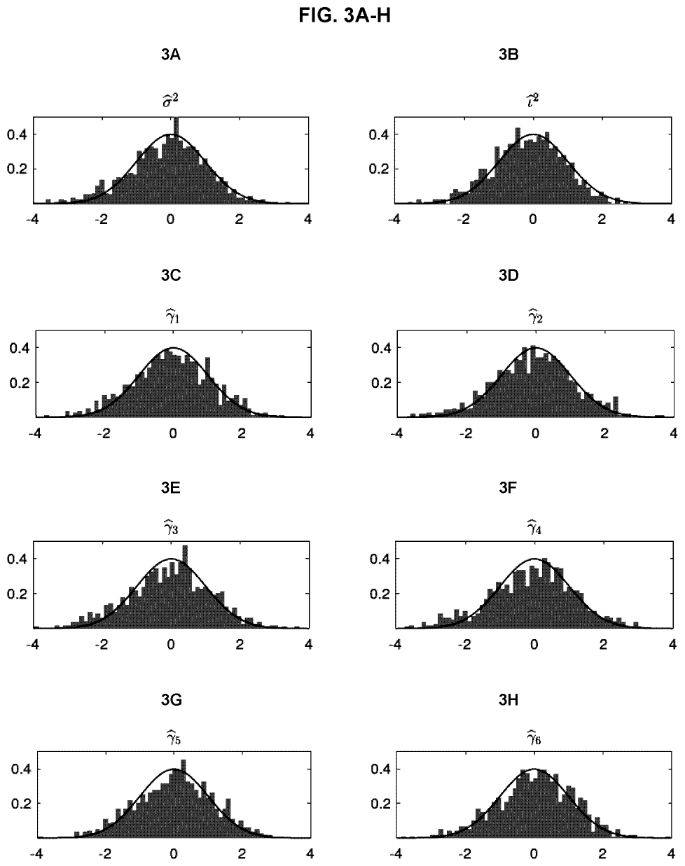

FIG. 3 illustrates histograms of standardized estimates using different estimated asymptotic variances. That is, FIG. 3 shows histograms of the standardized estimates along with the density of the standard normal distribution. The noise is simulated from an MA(5) model. FIG. 3A shows a histogram for a first standardized estimate of volatility under a first estimated asymptotic condition. FIG. 3B shows a histogram for a second standardized estimate of the variance of noise under the first estimated asymptotic condition. FIG. 3C shows a histogram for a third standardized estimate of variance of noise under the first estimated asymptotic condition. FIG. 3D shows a histogram for a second standardized estimate of the first order auto-covariance of noise under a second estimated asymptotic condition. FIG. 3E shows a histogram for a second standardized estimate of the second order auto-covariance of noise under a third estimated asymptotic condition. FIG. 3F shows a histogram for a second standardized estimate of the third order auto-covariance of noise under a fourth estimated asymptotic condition. FIG. 3G shows a histogram for a second standardized estimate of the fourth order auto-covariance of noise under a fifth estimated asymptotic condition. FIG. 3H shows a histogram for a second standardized estimate of the fifth order auto-covariance of noise under a sixth estimated asymptotic condition.

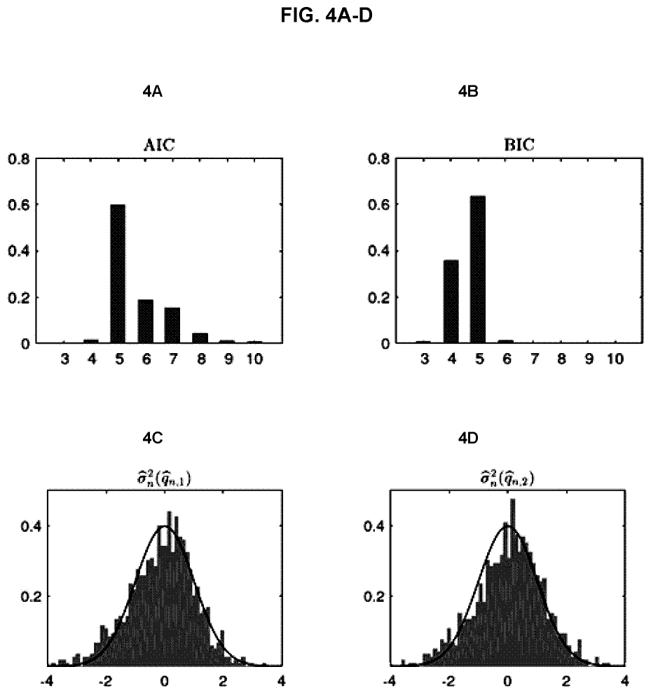

FIG. 4 generally illustrates histograms of the selected orders and the standardized volatility estimates. Specifically, FIG. 4A illustrates a histogram for a selected order using AIC. FIG. 4B illustrates a histogram for a selected order using BIC. FIG. 4C illustrates a histogram for the standardized volatility estimates using AIC. FIG. 4D illustrates a histogram for the standardized volatility estimates using BIC. The noise is simulated from an MA(5) model.

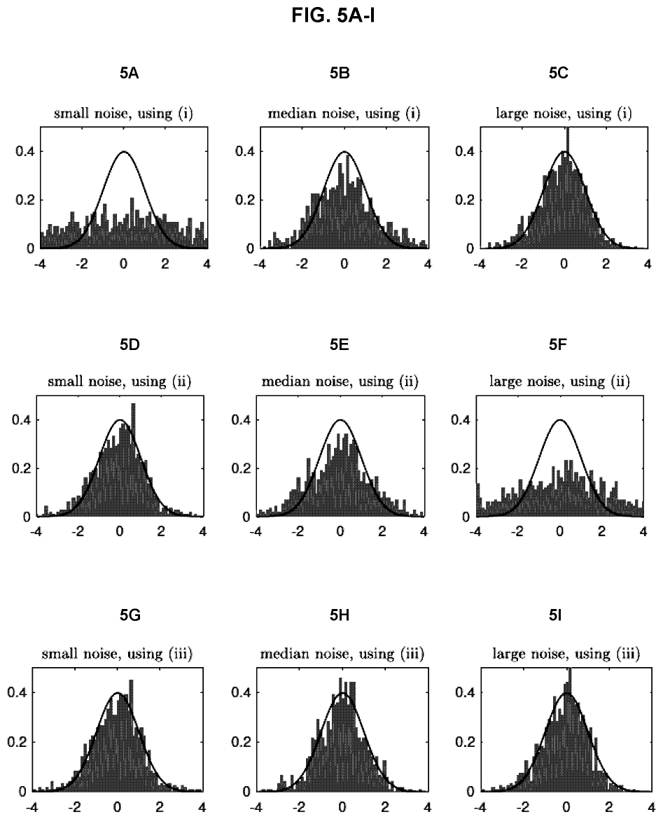

FIG. 5 generally compares histograms of the standardized estimates using estimated asymptotic variances across different scenarios. That is, FIG. 5 generally plots the histograms of the standardized estimates using the central limit results given by Theorem 4 (i) (FIGS. 5A-5C), Theorem 4 (ii) (FIGS. 5D-5F), and Theorem 4 (iii) (FIGS. 5H-5J). The solid lines plot the density of the standard normal distribution. The noise is simulated from an MA(5) model. Specifically, FIG. 5A shows a histogram for the central limit given by Theorem 4(i) in a low noise environment. FIG. 5B shows a histogram for the central limit given by Theorem 4(i) in a medium noise environment. FIG. 5C shows a histogram for the central limit given by Theorem 4(i) in a high noise environment. FIG. 5D shows a histogram for the central limit given by Theorem 4(ii) in a low noise environment. FIG. 5E shows a histogram for the central limit given by Theorem 4(ii) in a medium noise environment. FIG. 5F shows a histogram for the central limit given by Theorem 4(ii) in a high noise environment. FIG. 5G shows a histogram for the central limit given by Theorem 4(iii) in a low noise environment. FIG. 5H shows a histogram for the central limit given by Theorem 4(iii) in a medium noise environment. FIG. 5I shows a histogram for the central limit given by Theorem 4(iii) in a high noise environment.

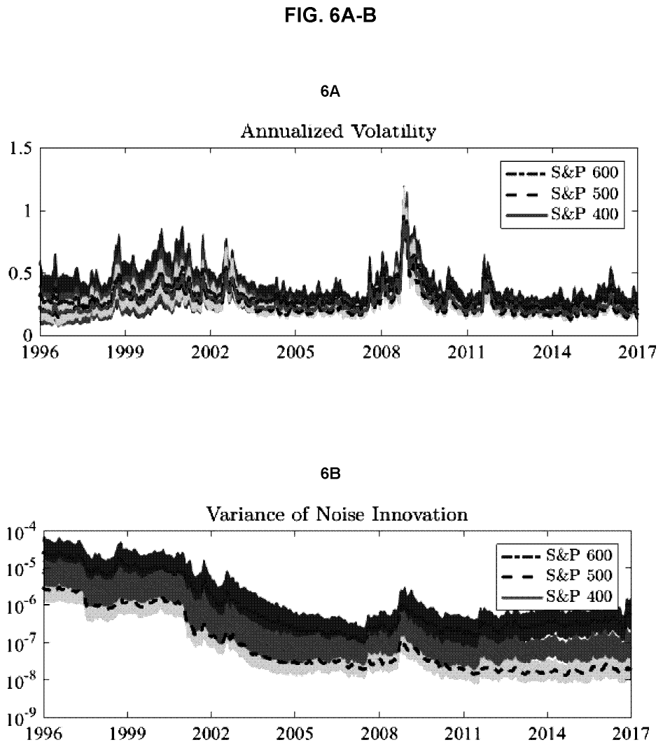

FIG. 6 illustrates a time series of estimated volatility and noise-innovation variance according to concepts described herein. FIG. 6A compares the cross-sectional median (lines), lower, and upper quartiles (shaded areas) of the annualized volatility estimates for S&P Composite 1500 Index constituents calculated according to embodiments herein. That is, FIG. 6A shows the time series of volatility estimates for constituents of each of the three indices, respectively. Lines are used to represent the median, and shaded areas are used to represent the lower and upper quartiles in the cross section. Embodiments also smooth these time series using equal weights over a monthly moving window. Although considerable cross-sectional variation is present, the median volatility estimates among constituents of all three indices share a similar pattern to volatility of the S&P 500 index. That said, the small caps are on average higher volatile than the large caps, with the mid-caps in between.

FIG. 6B illustrates the variance estimates of noise innovation calculated according to embodiments herein, i.e., for those constituents that have sufficiently high noises. The time series are smoothed with equal weights over a moving window of 21 days. The y-axis of FIG. 6B is transformed to the logarithm scale for the sake of presentation.

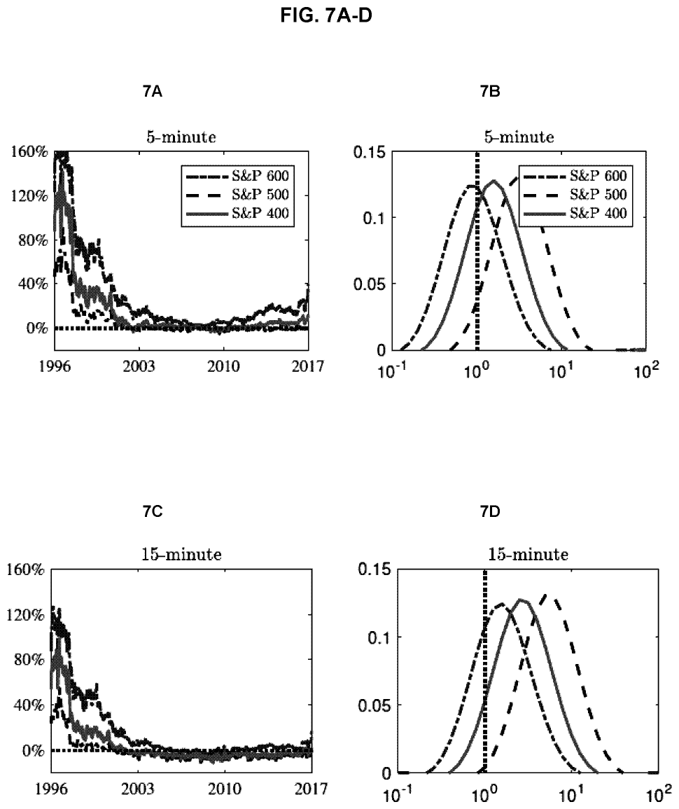

FIG. 7 generally shows relative biases and standard errors of the realized volatility against QMLE. FIG. 7A shows a plot of percentage bias in the cross-sectional medians of 5-minute volatility estimates, relative to the corresponding QMLEs using the entire sample. FIG. 7B shows a plot of percentage bias in the cross-sectional medians of 15-minute volatility estimates, relative to the corresponding QMLEs using the entire sample. The time series are smoothed with equal weights over a moving window of 21 days.

FIG. 7C shows a histograms of the ratios of standard errors between the 5-minute realized volatility estimator and the QMLE, for each stock-day pair in 2016. FIG. 7D shows a histograms of the ratios of standard errors between the 15-minute realized volatility estimator and the QMLE, for each stock-day pair in 2016. The x-axes in FIGS. 7C and 7D are transformed to the logarithm scale for the sake of presentation.

Referring to FIGS. 7A and 7C, on average, a large upward bias is present that is associated with the former estimates, potentially due to presence of the noises at the 5-minute frequency. The biases are substantial, up to over 160% for small caps, compared to the noise-robust QMLEs in earlier years. The biases have been decreasing over the past two decades, with a slight increase post 2008. The biases of the small caps are higher evident than those of the large caps. On average, the large caps are traded higher frequently than every 5 minutes, so embodiments are not surprised to see their biases in the cross-sectional medians are almost indistinguishable from 0 post 2002. This finding does not imply that every 5 minute is a safe frequency for each individual constituent of the S&P 500 index. At a 15-minute frequency, the biases are clearly smaller, though have not completely vanished even in 2016 for these median estimates.

FIGS. 7B and 7D demonstrate issues with inference based on the realized volatility estimator. That is, when the daily number of observations is larger than 78 (resp. 26), the confidence interval based on the 5-minute (resp. 15-minute) realized volatility estimator should be wider than that based on the efficiency bound discussed herein.

The ratios of standard errors between the 5-minute (resp. 15-minute) realized volatility estimator and the QMLE using the entire sample are compared, because the latter estimator is fairly close to achieving the efficiency bound. Because any estimator using subsamples is less efficient than the full-sample efficiency bound, this ratio should be greater than 1. Also, the larger the ratio is, the greater the efficiency loss for the realized volatility. Only results of 2016 are reported because the quality of 5-minute realized volatility estimator is best. Only when the sampling frequency is 15 minutes and only for S&P 500 constituents are almost all ratios larger than 1. Nonetheless, these ratios could be as large as higher than 10, indicating substantial efficiency losses. For other cases, considerable stock-day pairs exist for which inference using realized volatility estimators is overcondent.

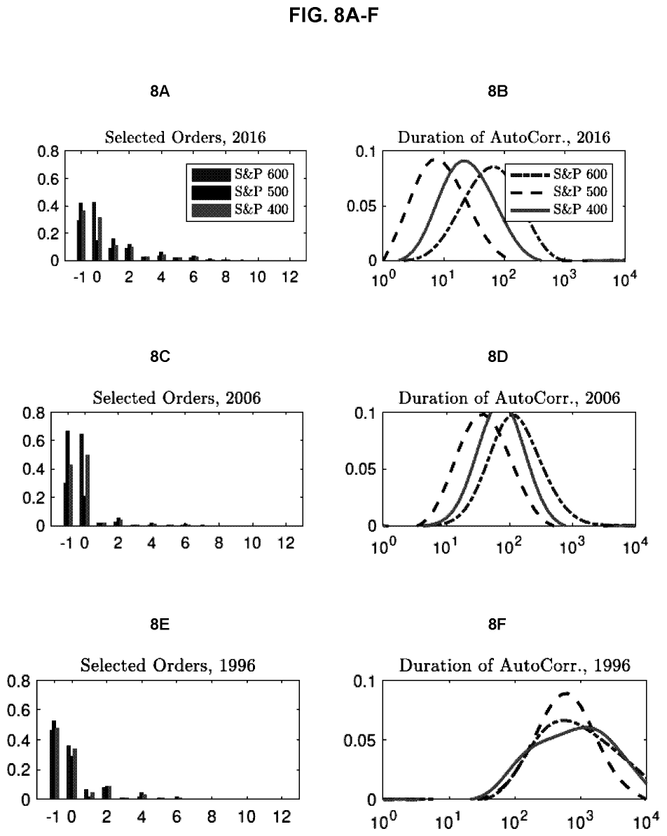

FIG. 8 generally illustrates certain aspects of statistical properties of the microstructure noise. According to FIGS. 8A, 8C, and 8E, 30%-60% of stocks have noises that are too small to be estimated. This percentage is slightly higher for large caps than for small caps. FIG. 6 suggests the noise magnitude has been shrinking perhaps due to the decimalization of the US security markets and the advent of electronic trading. In addition, not surprisingly, small-cap stocks exhibit larger noises than the mid- and large caps.

FIGS. 8A, 8C, and 8E also provide selected orders using BIC for constituents of each index, respectively. For a large percentage of stock-day pairs, the selected orders are 0, so that i.i.d. noise assumption is reasonable for them. That said, about 10%-30% of stock-day pairs remain for which BIC prefers a few higher lags. For BIC to select higher than 6 lags is rare. Embodiments identify higher stock-days in 2016 with selected orders greater than or equal to 1, compared to earlier years, in particular for large caps. This finding is due to the availability of data sampled at a frequency even higher than every second, for which it is expected to see higher auto-correlated lags.

To further shed light on this point, FIGS. 8B, 8D, and 8F provides histograms of the durations of auto-correlations for those tickers with selected lags greater than or equal to 1. The duration is defined in terms of seconds as the product of the selected order and the average trading frequency for each stock-day pair. Embodiments find the estimated durations are much smaller for large-cap stocks than for smaller caps. Moreover, the average duration of auto-correlations has been decreasing in the past two decades. For instance, the average duration of large caps has decreased from about 103 to merely 10 seconds.

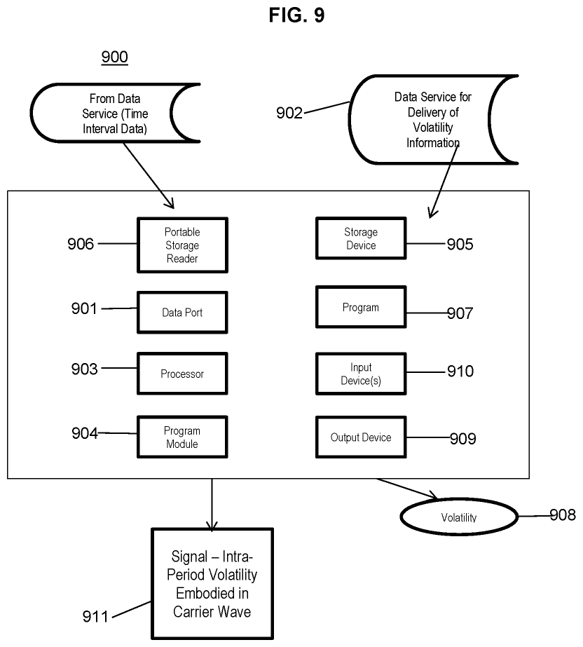

FIG. 9 illustrates computer-implemented system 900 for estimating volatility of a security according to an embodiment. System 900 comprises data port 901 for receiving time interval data from data service 902. System 900 may be a computer or may also have other embodiments such as hand-held devices. Methods for receiving time interval data include but are not limited to receiving data over the Internet or analogous communications network, receiving time interval data directly from a data provider, inputting the data by way of a storage medium, or disk or manually entering the time interval data.

System 900 comprises processor 903 programmed with instructions to perform data screening. The filtering may be performed with a stand-alone program written in languages or be implemented using a scripting language.

System 900 comprises software code or program module 904 programmed to execute the estimation strategy selected by the user. Running a simulation using a estimation strategy involves hypothetically executing a series of trades and examining the profit or loss associated with each. This simple simulation technique can be programmed using any of the programming languages or script-supplemented software packages described herein

Price values can be recorded to storage device 905 for use in estimating volatility. System 900 can also comprise a portable storage reader 906 s or removal hard drive containing historical time interval data. Portable storage reader 906 communicates with processor 903 to perform a number of calculations to estimate volatility.

System 900 can further comprise program 907 or program module 904. The term “module” referenced in this disclosure is meant to broadly cover various types of software code including but not limited to routines, functions, objects, libraries, classes, members, packages, procedures, or lines of code together performing similar functionality to these types of coding. Storage device 905 is also included for recording variables, positions, and other purposes to retrieve and calculate needed information. Time interval data required for this calculation may be received via portable storage media from a data service such as Reuters or New York Stock Exchange TAQ Database or over a communications network such as the Internet by data port 901, such as, for example, a network card, a serial port, parallel port, firewire port, or network card configured to communicate with a network wirelessly. Certain other values needed to calculate the intra-period volatility 908 may also be received by system 900 from data services such as Bloomberg.

System 900 also includes output device 909, such as, for example, a graphical user interface (GUI) or network interface which prompts or instructs the user or system to perform calculations, i.e., estimation intervals, corrective steps, etc., and to output the intra-period volatility after being estimated.

According to an embodiment, output device 909 is a GUI dynamically and/or statically displays several locations of fields of information and receives commands or entries from a user or user device based on the displayed information. Doing so allows a user to leverage the estimated volatility and noise components associated with a security or future on one or more exchanges.

Output device 909 can graphically display an estimated volatility of a security of future based on intraday trading data related to that security or future in one or more electronic exchanges. In doing so, output device 909 can dynamically display a first indicator in one of a plurality of locations in a price display region, where the first indicator represents security transaction price data sampled during a time interval. Output device 909 can also dynamically display a second indicator in one of a plurality of locations in a filter display region, where the second indicator represents security transaction price data that has been filtered to remove unreliable data relating to the security transaction price data sampled during the time interval. Output device 909 can further dynamically display a volatility estimator region comprising a first location corresponding to an estimated volatility of the security transaction price data sampled during the time interval, a second location corresponding to a latent efficiency security price, and a third location corresponding to a noise component.

Displaying the volatility estimator region can include displaying the estimated volatility, and/or the latent efficiency security price and noise component. The volatility estimator region can also include other fields of information, such a data sampling interval, a trade volume level, and the like.

Output device 909 can further dynamically display an interactive tool region comprising a plurality of locations for receiving commands, where the plurality of locations for receiving commands correspond to at least one of: the displayed estimated volatility, the displayed latent efficiency security price, and the displayed noise component.

Further, in response to a selection of a particular location from a user or user input device, output device 909 can configure plurality of parameters for a buy or sell order relating to a security or future. The parameter can correspond to, e.g., a buy or sell order on one or more of the electronic exchange.

The configuration of output device 909 itself informs the user in a more convenient and efficient manner than existing systems. Users gain a significant advantage by seeing the market volatility because they can see trends in the market with noise or micro-noise removed. This allows the user to better calculate risk associated with a given trade or the like. A volatility estimator display can also show the user latent efficiency prices and/or estimated noise in the market for a given security or future at different price levels. Volume levels can also be displayed in conjunction with estimated noise. If a large amount of orders are in the market near the user's position, he may feel he should sell or buy. Without seeing (filtered) volatility and/or volatility in conjunction with estimated noise, no such strategies could be utilized. Dynamically displaying such data (over any number of selected time intervals) conveys the information to the user in a more intuitive and easily understandable manner. T rends in the trading the security or future and other relevant characteristics are more easily identifiable by the user through the use of the present invention.

System 900 also includes one or higher input devices 910, such as, for example, a keyboard and mouse, to allow a user to communicate with system 900, and a translating device, such as for example, a compression chip on a network card, for translating intra-period volatility 908 and other data involved with determining the intra-period volatility into a digital data signal 911, intra-period volatility 908 contained therein may be used for one or higher of the purpose described herein.

For example, data signal 911 may be received by a remote computer which is programmed to buy or sell securities. The remote computer might receive the intra-period volatility 908 in data signal 911, calculate the price of a security using the intra-period volatility, and execute a buy or sell when there is a favorable discrepancy, such as buying a security being sold below its calculated value.

Data signal 911 may be configured to operate over commonly used network or communications protocols. With such protocols, system 900 processes data signal 911 into a compressed signal, encrypts the compressed signal, and transmits the compressed and encrypted signal to the remote computer. The remote computer is programmed to decompress and decrypt the data signal so that the intra-period volatility can be utilized.

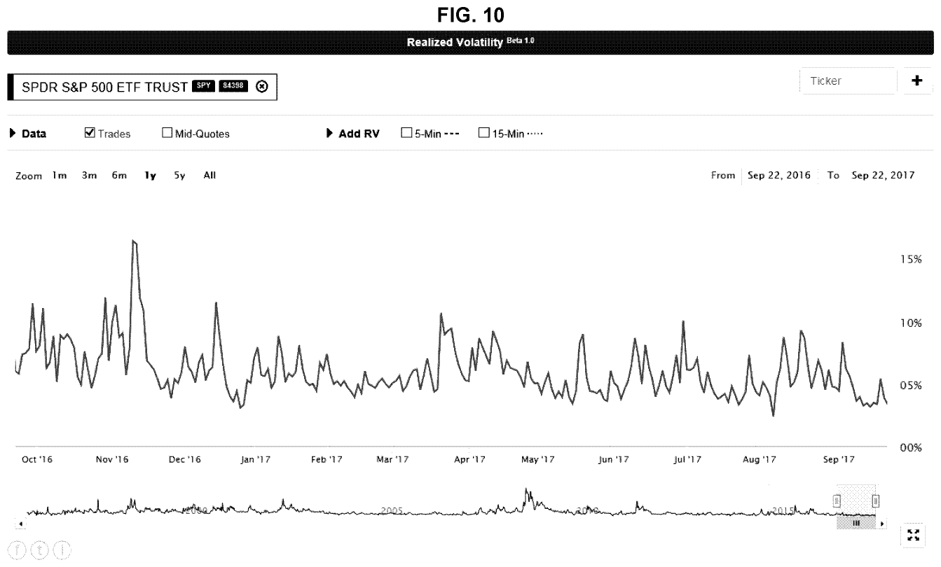

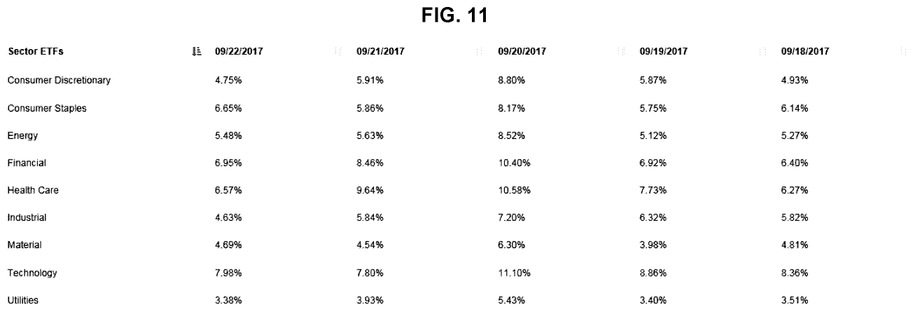

FIG. 10 illustrates certain aspects of an interactive tool that can be utilized to estimate volatility and/or take certain actions based on the estimated volatility. FIG. 11 illustrates other aspects of an interactive tool that can be utilized to estimate volatility and/or take certain actions based on the estimated volatility.

In view of their foregoing description, embodiments provide a simple volatility estimator based on the likelihood of an MA model, which is robust to dependent noise. Although this estimator relies on either AIC or BIC for model selection, embodiments utilize a uniformly valid post-selection inference on volatility, allowing for imperfect model selection.

In addition, the estimator is rate efficient and adaptive to the presence of the noise. As noise vanishes, its convergence rates increases from n^{1/4} to n^{1/2}. In light of this fact, embodiments provide a uniformly valid confidence interval for volatility, allowing for both small and large magnitudes of the noise. This estimator does not rely on a bandwidth choice, and it always guarantees the positivity of volatility estimates. For these reasons, the AIC-QMLE delivers more desirable finite-sample performance than alternative nonparametric estimators.

The described empirical study of S&P 1500 stocks highlights the limitations of applying the realized volatility estimator to a large cross section of stocks, where no safe frequency exists that one can use without accounting for the microstructure noise. Important by-products of this approach are the estimates of noise auto-covariances and auto-correlations. They are potentially informative about structural parameters of certain microstructure models, which embodiments leave for future work. This approach resembles a threshold estimator, which gives zero auto-covariance estimates beyond the lag selected by the information criterions. This feature delivers superior performance in the finite sample, particularly when noise is relatively small. Empirically, embodiments find that auto-covariances of observed returns in recent years last for a much shorter period of time compared to earlier years, indicating the market efficiency has improved substantially, potentially due to the popularity of electronic and algorithmic trading. In a cross-sectional comparison, auto-covariances of small-cap stocks tend to persist for a longer period than the large caps, potentially due to limits to arbitrage or for some liquidity reasons.

Although the present invention and its advantages have been described in detail, it should be understood that various changes, substitutions and alterations can be made herein without departing from the spirit and scope of the invention as defined by the appended claims. Moreover, the scope of the present application is not intended to be limited to the particular embodiments of the process, machine, manufacture, composition of matter, means, methods and steps described in the specification. As one of ordinary skill in the art will readily appreciate from the disclosure of the present invention, processes, machines, manufacture, compositions of matter, means, methods, or steps, presently existing or later to be developed that perform substantially the same function or achieve substantially the same result as the corresponding embodiments described herein may be utilized according to the present invention. Accordingly, the appended claims are intended to include within their scope such processes, machines, manufacture, compositions of matter, means, methods, or steps. Moreover, the scope of the present application is not intended to be limited to the particular embodiments of the process, machine, manufacture, composition of matter, means, methods and steps described in the specification.

1. A method for estimating the volatility of a security based on intraday trading data relating to that security, the method comprising:
receiving security transaction price data that is sampled during a time interval;
filtering the received security transaction price data to remove unreliable data;
calculating, from the filtered sample of transaction price data of a security, a volatility estimator based on an assumption that a transaction price of a security comprises: the sum of (1) a latent efficient security price that follows a general Itô semimartingale, and (2) a market microstructure noise component that follows a discrete-time moving-average (MA)(∞) associated with the random execution of trades;
where the estimator is further calculated by maximizing the likelihood of a mis-specified moving-average (MA) model of returns with homoscedastic innovations;
utilizing Quasi-Maximum Likelihood Estimator (QMLE) to determine volatility and noise for the security; and
based on the determined volatility and noise, instructing, via an interactive tool, a user to take one or more actions, where the interactive tool:
dynamically displays first indicator representing security transaction price data sampled during a time interval;
dynamically displays a second indicator representing filtered security transaction price data;
dynamically displaying a volatility estimator region; and
dynamically displays a region comprising a plurality of locations for receiving commands, the plurality of locations for receiving commands corresponding to at least one of: the displayed estimated volatility, the displayed latent efficiency security price, and the displayed noise component,
where the commands comprise at least one of a buy or sell command based on the displayed volatility.

2. The method of claim 1 where the logarithm of the efficient equilibrium security price is treated as a Brownian motion with constant volatility.

3. The method of claim 1 where a mis-specified Moving Average (MA) model of returns is expressed as:
$${dX}_{t} = σ {dW}_{t} ;$$
$${U}_{i} = τ {θ ( B )}_{ɛ i} , with θ ( x ) = 1 + {\sum }_{j = 1}^{q} {θ}_{j} {x}^{j} , and {ϵ}_{i} ∼ N ( 0 , 1 ) .$$

4. The method of claim 3 where the order of q is determined by minimizing one of Akaike Information Criteria (AIC) or Bayesian Information Criteria (BIC).

5. The method of claim 1 where the security transaction price data is randomly sampled during the time interval.

6. The method of claim 1 where the security transaction price data is sampled at uniform increments during the time interval.

7. A system for estimating the volatility of a security based on intraday trading data relating to that security, the system comprising:
a memory;
one or more processors coupled to the memory, the one or more processors:
receiving security transaction price data that is sampled during a time interval;
filtering the received security transaction price data to remove unreliable data;
calculating, from the filtered sample of transaction price data of a security, a volatility estimator based on an assumption that a transaction price of a security comprises: the sum of (1) a latent efficient security price that follows a general Itô semimartingale, and (2) a market microstructure noise component that follows a discrete-time moving-average (MA)(∞) associated with the random execution of trades;
where the estimator is further calculated by maximizing the likelihood of a mis-specified moving-average (MA) model of returns with homoscedastic innovations;
utilizing Quasi-Maximum Likelihood Estimator (QMLE) to determine volatility and noise for the security; and
based on the determined volatility and noise, instructing, via an interactive tool, a user to take one or more actions, where the interactive tool:
dynamically displays first indicator representing security transaction price data sampled during a time interval;
dynamically displays a second indicator representing filtered security transaction price data;
dynamically displaying a volatility estimator region; and
dynamically displays a region comprising a plurality of locations for receiving commands, the plurality of locations for receiving commands corresponding to at least one of: the displayed estimated volatility, the displayed latent efficiency security price, and the displayed noise component,
where the commands comprise at least one of a buy or sell command based on the displayed volatility.

8. The system of claim 7 where the logarithm of the efficient equilibrium security price is treated as a Brownian motion with constant volatility.

9. The system of claim 7 where a mis-specified Moving Average (MA) model of returns is expressed as:
$${dX}_{t} = σ {dW}_{t} ;$$
$${U}_{i} = τ {θ ( B )}_{ɛ i} , with θ ( x ) = 1 + {\sum }_{j = 1}^{q} {θ}_{j} {x}^{j} , and {ϵ}_{i} ∼ N ( 0 , 1 ) .$$

10. The system of claim 9 where the order of q is determined by minimizing one of Akaike Information Criteria (AIC) or Bayesian Information Criteria (BIC).

11. The system of claim 7 where the security transaction price data is randomly sampled during the time interval.

12. The system of claim 7 where the security transaction price data is sampled at uniform increments during the time interval.

13. A method for displaying an estimated volatility of a security based on intraday trading data related to that security in an electronic exchange on a graphical user interface, the method comprising:
dynamically displaying a first indicator in one of a plurality of locations in a price display region, the first indicator representing security transaction price data sampled during a time interval;
dynamically displaying a second indicator in one of a plurality of locations in a filter display region, the second indicator representing security transaction price data that has been filtered to remove unreliable data relating to the security transaction price data sampled during the time interval;
dynamically displaying a volatility estimator region comprising a first location corresponding to an estimated volatility of the security transaction price data sampled during the time interval, a second location corresponding to a latent efficiency security price, and a third location corresponding to a noise component, where displaying the volatility estimator region comprises displaying at least one of:
the estimated volatility, and
the latent efficiency security price and noise component; and
dynamically displaying an interactive tool region comprising a plurality of locations for receiving commands, plurality of locations for receiving commands correspond to at least one of: the displayed estimated volatility, the displayed latent efficiency security price, and the displayed noise component.

14. A computer readable medium having program code recorded thereon for execution on a computer for displaying an estimated volatility of a security based on intraday trading data related to that security in an electronic exchange on a graphical user interface, the program code causing a machine to perform the following method steps:
dynamically displaying a first indicator in one of a plurality of locations in a price display region, the first indicator representing security transaction price data sampled during a time interval;
dynamically displaying a second indicator in one of a plurality of locations in a filter display region, the second indicator representing security transaction price data that has been filtered to remove unreliable data relating to the security transaction price data sampled during the time interval;
dynamically displaying a volatility estimator region comprising a first location corresponding to an estimated volatility of the security transaction price data sampled during the time interval, a second location corresponding to a latent efficiency security price, and a third location corresponding to a noise component, where displaying the volatility estimator region comprises displaying at least one of:
the estimated volatility, and
the latent efficiency security price and noise component; and
dynamically displaying an interactive tool region comprising a plurality of locations for receiving commands, plurality of locations for receiving commands correspond to at least one of: the displayed estimated volatility, the displayed latent efficiency security price, and the displayed noise component.
